(19) United States
(12) Patent Application Publication
(10) Pub. No.: US 2014/0166913 A1
(43) Pub. Date: Jun. 19, 2014

(54) Pin Mechanism

(71) Applicants: Andrew Phillips, Rochester, NY (US); George F. Howard, Cape Vincent, NY (US)

(72) Inventors: Andrew Phillips, Rochester, NY (US); George F. Howard, Cape Vincent, NY (US)

(73) Assignee: G.W. LISK COMPANY, INC., Clifton Springs, NY (US)

(21) Appl. No.: 14/236,479

(22) PCT Filed: Dec. 22, 2011
(86) PCT No.: PCT/US2011/066836

§ 371 Date: Jan. 31, 2014

Related U.S. Application Data
(60) Provisional application No. 61/514,145, filed on Aug. 2, 2011.

(51) Int. Cl. F16K 35/06

(52) U.S. Cl. CPC F16K 35/06
USPC 251/89

(57) ABSTRACT

Pin release mechanism comprising: a release pin axially movable from a first position to a second position; a bias spring biasing the release pin towards the second position; a pull rod interacting with ball bearings, the pull rod having a locked position in which ball bearings radially interfere with movement of the release pin and prevent movement of the release pin from the first position to a second position, and an unlocked position in which the ball bearings may move radially relative to the pull rod to allow the release pin to move from the first position towards the second position; a solenoid, which when actuated moves the pull rod toward the unlocked position; and a bias pin coupled to the pull rod, biased by a spring pushing between the release pin and the bias pin, to bias the bias pin and the pull rod toward the second, unlocked direction.

### BACKGROUND OF THE INVENTION

1. Field of the Invention

The invention pertains to the field of pin mechanisms. More particularly, the invention pertains to a pin mechanism for a fire extinguisher.

2. Description of Related Art

FIGS. 1-2 show a prior art solenoid actuator in a released position and an unreleased position respectively.

The solenoid actuator has a housing 101 with a first bore 102 for slidably receiving a release pin 117 and a second bore 120 for receiving a solenoid assembly 121.

The release pin 117 has a collar 122 that slides along the surface of the first bore 102 of the housing 101 and a shaft portion 123 that is slidably received within a cap 103 closing off the first bore 102 of the housing 101. A release spring 106 is present between the release pin 117 and the cap 103.

Between the collar 122 and the shaft portion 123 of the release pin 117 is a neck portion 124. A ramp section or angled surface 125 is present between the collar 122 and the neck portion 124 of the release pin 117.

Slidably received within an open bore 107 of the neck portion 124 of the release pin 117 is a detent retainer 114. The detent retainer 114 has an inner surface defining a bore 118 for receiving a release spool 109. The inner surface of the bore 118 of the detent retainer 114 includes a straight surface 126 which is connected to an angled ramp section 119.

The release spool 109 has a cavity 127 which receives a first ball bearing 115a attached to a second ball bearing 115b through a retention spring 116. The release spool 109 is also coupled to a first end 113a of a push rod 113.

The solenoid assembly 121 received within the second bore 120 of the housing 101 includes at least one coil 111 connected to a power source (not shown), a solenoid spool 110, and a moveable armature 112. Connected to the moveable armature 112 is a second end 113b of a push rod 113.

In the unreleased position, as shown in FIG. 2, the collar 122 of the release pin 117 is not in contact with the end of the first bore 102 and the release spring 106 is compressed between the collar 122 of the release pin 117 and the cap 103. The release pin 117 is maintained in this position by the first and second ball bearings 115a, 115b engaging the angled surface 125 of the collar 122 of the release pin 117 and the flat surface 126 of the detent retainer 114. The first and second ball bearings 115a, 115b are held against the angled surface 125 of the collar 122 and the straight surface 126 of the detent retainer 124 by the retention spring 116.

To move the solenoid actuator to a released position as shown in FIG. 1, at least one coil 111 of the solenoid assembly 121 is energized and pulls the armature 112 away from the cap 103. Movement of the armature 112 moves the push rod 113 away from the cap 103, pulling the release spool 109 away from the cap 103. The movement of the release spool 109 allows the first and second ball bearings 115a, 115b to travel from the straight surface 126 of the detent retainer 114 to the ramp section 119 of the detent retainer 114, compressing the retention spring 116 between the ball bearings 115a, 115b. The movement of the first and second ball bearings 115a, 115b to the ramp section 119 of the detent retainer 114 removes any force on the collar 122 of the release pin 117, allowing the release spring 106 to move the release pin 117 to a position where the collar 122 is in contact with the end of the first bore 101.

The solenoid actuator of FIGS. 1-2 is resettable by moving the shaft portion 123 of the release pin 117 in a direction away from the solenoid assembly 121. The movement of the shaft portion 123 of the release pin 117 in this direction allows the retention spring 116 to bias the ball bearings 115a, 115b outwards to contact the ramp section 125 of the detent retainer 114 and to eventually come in contact with the angled surface 125 of the collar 122 of the release pin 117 as shown in FIG. 2.

It should be noted that there is not a bias force that acts directly on the push rod 113 that moves the armature 112 of the solenoid assembly 121.

FIG. 3 shows another prior art solenoid actuator in an unreleased position. The solenoid actuator has a housing 201 with a first bore 202 for slidably receiving a release pin 217 and a second bore 220 for receiving a solenoid assembly 221.

The release pin 217 has a collar 222 that slides along the inner surface of the first bore 202 of the housing 201 and a shaft portion 223 that is slidably received within a cap 203 closing off the first bore 202 of the housing 201. A release spring 206 is present between the release pin 217 and the cap 203.

Between the collar 222 and the shaft portion 223 of the release pin 217 is a neck portion 224. A ramp section or angled surface 225 is present between the collar 222 and the neck portion 224 of the release pin 217.

Slidably received within an open bore 207 of the neck portion 224 of the release pin 217 is a detent retainer 214. The detent retainer 214 has an inner surface defining a bore 218 for receiving a release spool 209. A circumferential groove 230 with straight edges 231 present along an outer surface of the detent retainer 214 and receive ball bearings 215. A compression spring 232 is present between the detent retainer 214 and the release spool 209, linking the detent retainer 214 to the release spool 209.

On the outer circumference of the release spool 209 is a groove section 234 including a ramp 235 between two straight surfaces 240, 241. The ball bearings may travel from straight surface 240 to the ramp 235 and come to rest on straight surface 241 as the release spool 209 slides within the bore 218 of the detent retainer 214. The detent retainer 214 is also coupled to a first end 213a of a push rod 213.

The solenoid assembly 221 includes at least one coil 211 connected to a power source (not shown), a solenoid spool 210, a moveable armature 212 and a stop 236. The second end 213b of the push rod 213 is connected to the moveable armature 212 and is slidably received by the stop 236. The movement of the armature 212 towards the release pin 217 is limited by the stop 236. Another compression spring 237, with the same spring force as the compression spring 232 between the detent retainer 214 and release spool 209 is present between the moveable armature 212 and the second bore 220 of the housing 201.

In an unreleased position, the collar 222 of the release pin 217 is not in contact with the end of the first bore 202 and the release spring 206 is compressed between the collar 222 of the release pin 217 and the cap 203. The release pin 217 is maintained in this position by the ball bearings 215 engaging the angled surface 125 of the collar 222 of the release pin 217, a straight edge 231 of the detent retainer 214, and a straight surface 240 of the groove section of the release spool.

To move the solenoid actuator to a released position (not shown), at least one coil 211 of the solenoid assembly 221 is energized and pushes the armature towards the cap 203. The movement of the armature 212 moves the push rod 213 towards the cap 203, pushing the detent retainer 214 and the release spool 209 towards the cap 203. The movement of the detent retainer 214 and the release spool 209 allows the ball bearings 215 to travel from the straight surface 240 to the ramp 235 and come to rest on straight surface 241 of the release spool 209. The movement of the ball bearings 215 to the ramp 235 of the release spool 209 removes any force on the collar 222 of the release pin 217, allowing the release spring 206 to move the release pin 217 to a position where the collar 222 is in contact with the end of the first bore 202.

The spring 232 between an end of the second bore 220 and the armature 212 provides a source of bias or spring force on the armature 212 that is specifically counteracted by the spring force of the spring 237 present between the release spool 209 and detent retainer 214. Therefore, a spring force that is in the direction of armature 212 movement that is not counteracted is not present.

### SUMMARY

According to an embodiment of the present invention, a pin release mechanism. The pin release mechanism comprising: a release pin axially movable from a first position to a second position; a bias spring biasing the release pin towards the second position; a pull rod interacting with a plurality of ball bearings, the pull rod having a locked position in which a plurality of ball bearings radially interfere with movement of the release pin and prevent movement of the release pin from the first position to a second position, and an unlocked position in which the plurality of ball bearings may move radially relative to the pull rod to allow the release pin to move from the first position towards the second position; a solenoid, which when actuated moves the pull rod toward the unlocked position; and a bias pin coupled to the pull rod, biased by a spring pushing between the release pin and the bias pin, to bias the bias pin and the pull rod toward the second, unlocked direction.

The present invention utilizes stored energy to achieve high forces across long distances while using relatively small packaged size solenoids.

### BRIEF DESCRIPTION OF THE DRAWINGS

FIGS. 1-2 show a released and an unreleased position of a prior art actuator.

FIG. 3 shows an unreleased position of another prior art actuator.

FIG. 4 shows a schematic of a pin mechanism in an unreleased position.

FIG. 5 shows a schematic of a pin mechanism in a released position.

FIG. 6 shows an exploded view of FIG. 4.

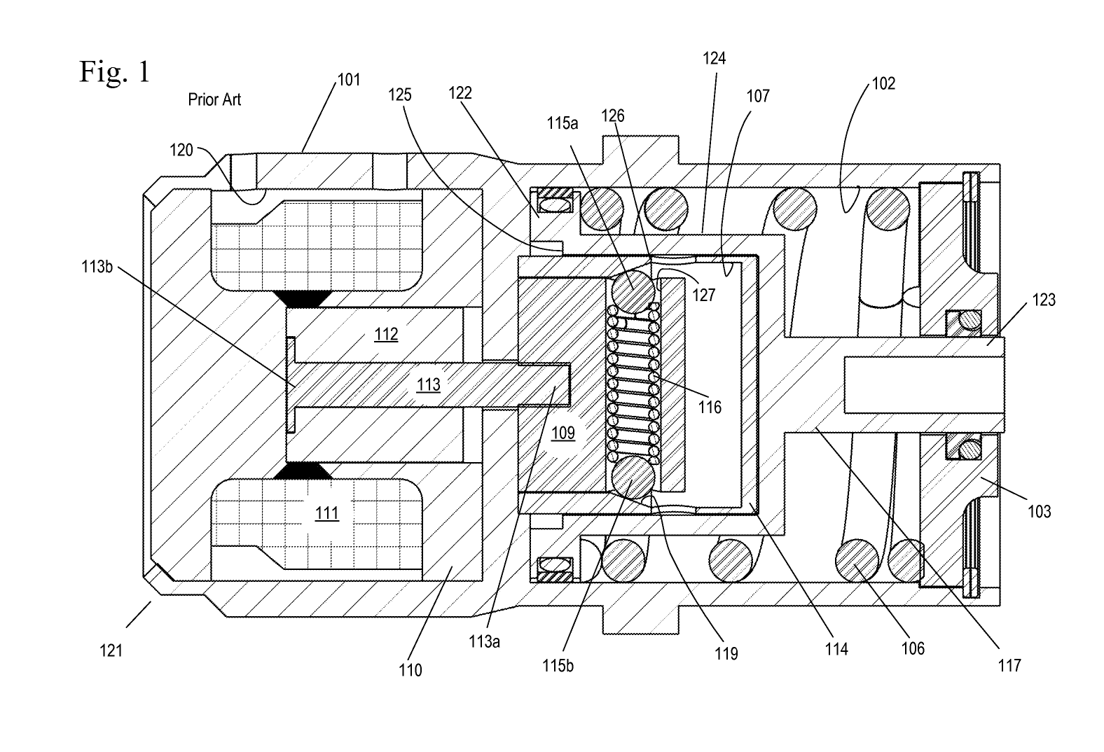

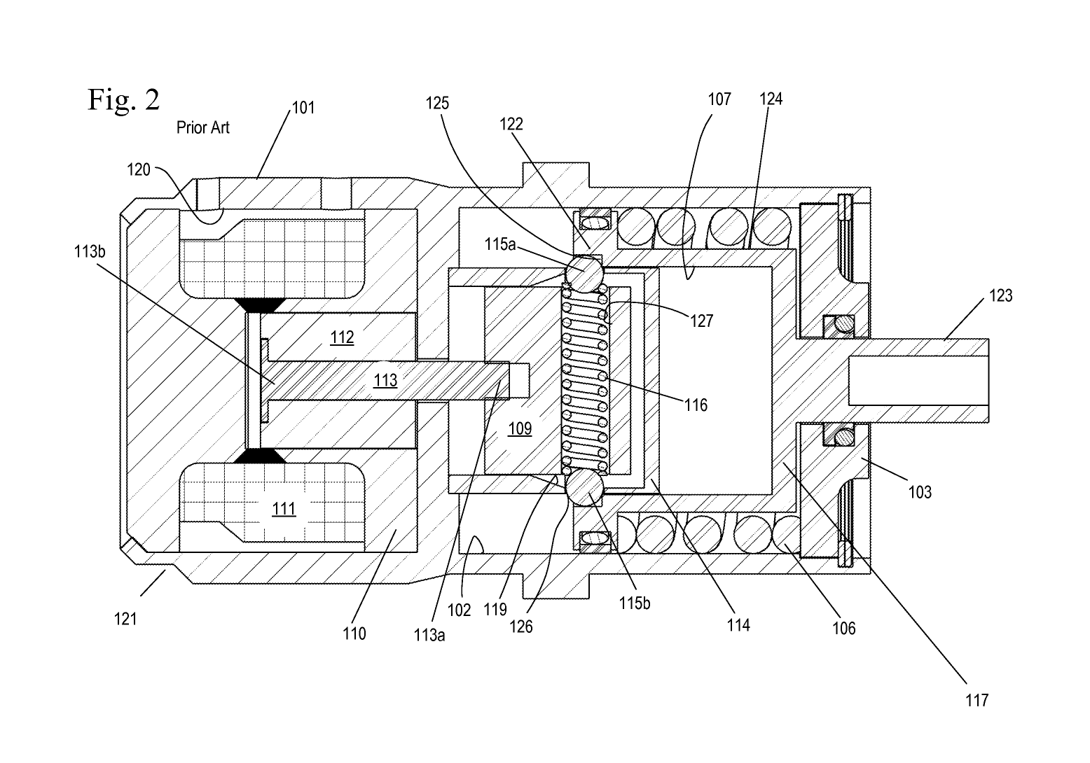

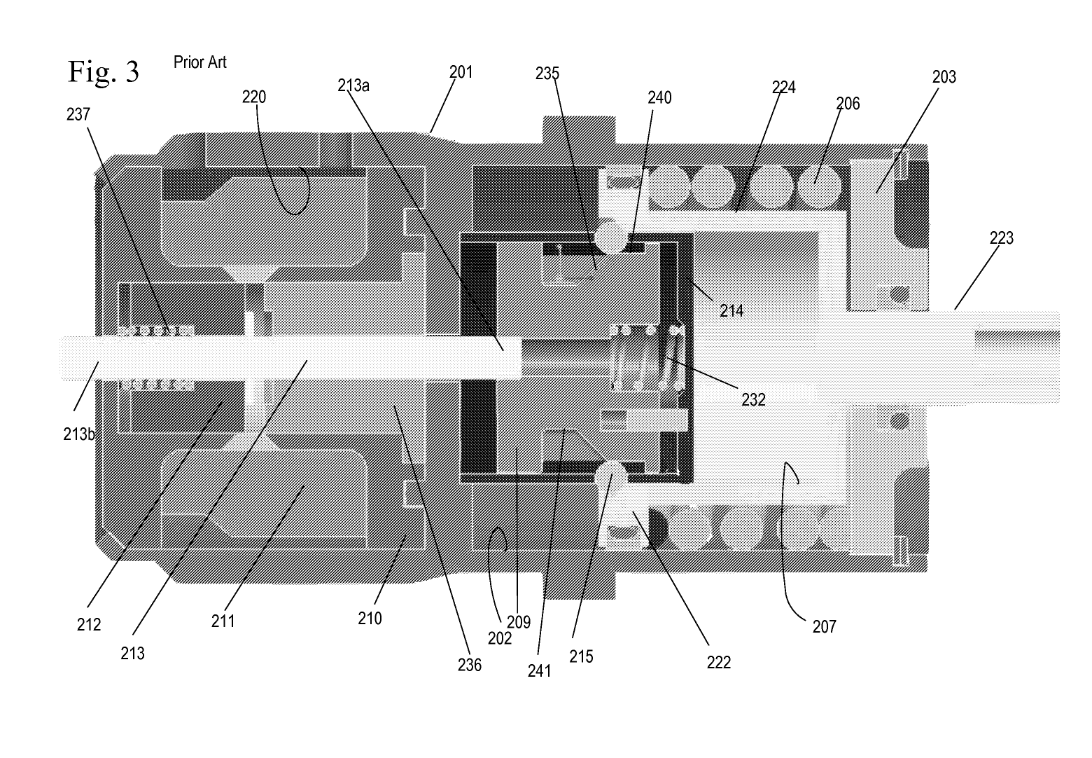

### DETAILED DESCRIPTION OF THE INVENTION

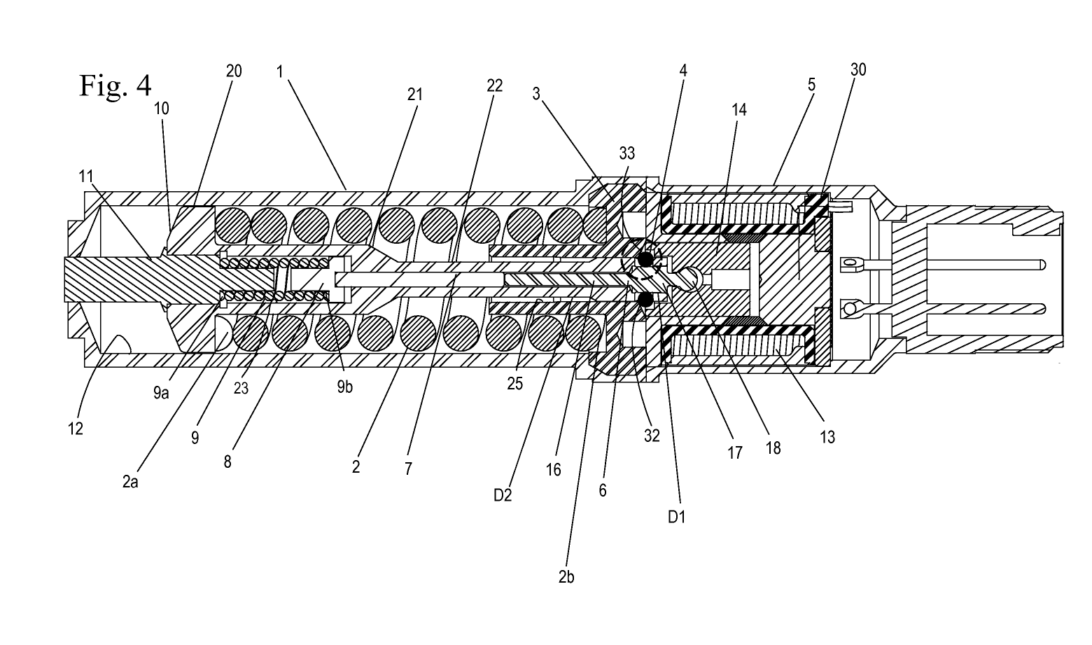

FIGS. 4-6 show a pin mechanism for releasing a pin. The pin mechanism of the present invention allows for high force values to be achieved over longer strokes with the use of an optimized solenoid package size. In one embodiment, the pin mechanism is preferably used for releasing a pin of a fire extinguisher.

The pin mechanism of the present invention has a spring housing 1 with a bore 12. Slidably received within the first end of the bore 12 is a release pin 10 with a head portion 20 connected to a shaft portion 22 through a neck portion 21. Extending from the head portion 20 of the release pin 10 is a bias spring retainer 11. The bias spring retainer 11 is threaded and locked into a pin (not shown) of fire extinguisher for example. A portion of the bias spring retainer 11 also extends within a bias spring bore 23 in the neck portion 21 of the release pin 10. The bias spring bore 23 is connected to a cavity 24 that extends a length of the shaft portion 22 of the release pin 10. A compressed bias spring 9 is present within the bias spring bore 23 with a first end of the spring 9a in contact with the bias spring retainer 11 and the second end 9b of the bias spring 9 in contact with a pin guide 8 slidable received within the bias spring bore 23. Integrally connected to the pin guide 8 is a bias pin 7 which extends a portion of the length of the cavity 24 of the shaft portion 22 of the release pin 10. An end of the shaft portion 22 is slidably received by a bore 25 defined by a spring guide 3.

A release spring 2 surrounds the neck portion 21 and shaft portion 22 of the release pin 10, with a first end 2a of the release spring 2 in contact with the head portion 20 of the release pin 10 and a second end 2b of the release spring 2 in contact with a spring guide 3. The release spring 2 moves the release pin 10 outward from the housing 1, or away from the solenoid assembly 50 while the second end 2b of the release spring 2 remains stationary and in contact with the spring guide 3. The spring guide 3 prevents the pull rod 6 from ever contacting the release spring 2, regardless of the position of the pull rod 6.

Within a second end of the bore 12 is a solenoid assembly 5. The solenoid assembly 5 includes at least one coil 13 connected to a power source (not shown), a bobbin 30, and a moveable armature 14. The moveable armature 14 receives a pull end 17 with an integrally connected a tab 18 of a pull rod 6. Opposite of the pull end 17 of the pull rod 6 is a rod end 16 which is received by the bore 25 of the spring guide 3 and within the cavity 24 of the shaft portion 22. The pull end 17 of the pull rod 6 has a first outer diameter portion D1 and the rod end 16 of the pull rod 6 has a second outer diameter portion D2. The transition between the first outer diameter portion D1 and the second outer diameter portion D2 is made through a ramp section 32 of the pull rod 6. The first outer diameter portion D1 is greater than the second outer diameter portion D2. At least two ball bearings 4 slide from the first outer diameter portion D1, down the ramp section 32 to the second outer diameter portion D2 as the pull rod 6 is moved from an unreleased position to a released position.

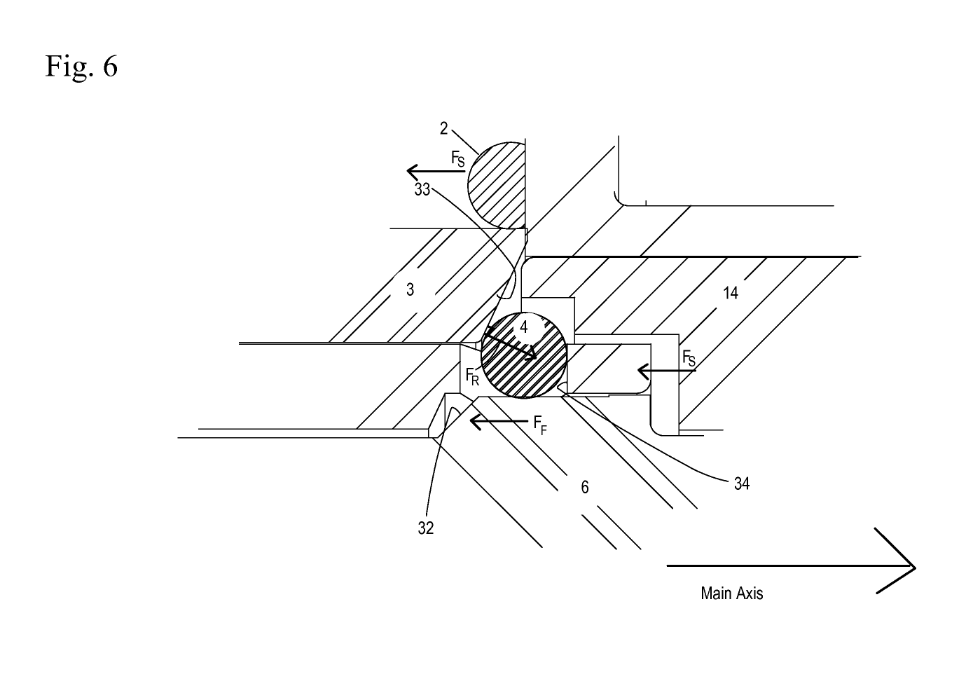

FIG. 6 shows an exploded view of a portion of FIG. 4 indicated by the dashed circle. The release spring 2 remains compressed by a frictional force F_{S} transmitted through the ball bearings 4 that are positioned between the pull rod 6, release pin 10 and the spring guide 3. In the unreleased position, the release pin 10, while compressed, is generating a force that is trying to pull the entire release pin 10 outward, this force vector creates a horizontal reaction force F_{F}, parallel to a main axis, at the ramp section 33 located on the spring guide 3. The main axis is the axis in which the pull pin 6 is moved along. The vertical component or force perpendicular to the main axis of this force vector F_{R} acting upon the ball bearings 4 via the slope of the surface 33 creates a frictional force that inherently locks the release spring 2 in the compressed position.

When the pin mechanism is in the unreleased position as shown in FIG. 4, the head portion 20 of the release pin 10 is not in contact with the end of the bore 12 of the spring housing 1 and the release spring 2 is compressed. The rod end 16 of the pull rod 6 biases the bias pin 7 and the pin guide 8 within the bias spring retainer 11, further compressing the bias spring 9. At least two ball bearings 4 are held in place on the first outer diameter portion D1 of the pull rod 6 by friction seating on both the spring guide 3 ramp section 33 and the surface 34 of the shaft portion 22 of the release pin 10.

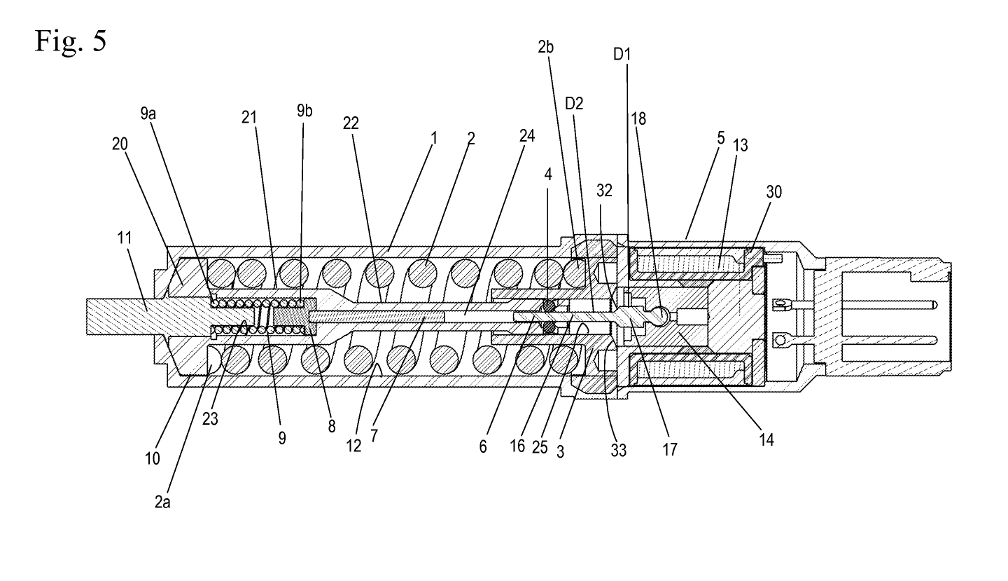

To release the pin mechanism from a released position to an unreleased position as shown in FIG. 5, at least one coil 13 is energized and pulls the armature 14 towards the solenoid assembly 50, pulling the tab 18 of the pull end 17 of the pull rod 6 towards the solenoid assembly 50. The movement of pull rod 6 towards the solenoid assembly 50 is aided by the force of the bias spring 9 within the bias spring retainer 11, biasing pin guide 8 and bias pin 7 against the rod end 16 of the pull rod 6.

The movement of the pull rod 6 towards the solenoid assembly 50 allows at least two ball bearings 4 to move from the first outer diameter portion D1, of the pull rod 6 down the ramp section 32 of the shaft portion 22 of the release pin 10, to the second outer diameter portion D2 of the pull rod 6, and simultaneously off of the ramp section 33 of the spring guide 3 and surface 34 of the shaft portion 22. The movement of the pull rod 6 towards the solenoid assembly 50 allows the pin guide 8 to also move towards the solenoid assembly 50. At the same time, the release spring 2 biases the release pin 10 and bias spring retainer 11 away from the solenoid assembly 50 until the head portion 20 of the release pin 10 is in contact with the end of the bore.

To reset the pin mechanism from an unreleased position to a released position, the pin mechanism needs to be manually reset. To reset the mechanism, the release spring 2 and release pin 10 must be compressed back to its initial position as shown in FIG. 4. By moving the release pin 10 to its initial position, the bias spring 9 and pull rod 6 are also moved back to the initial position shown in FIG. 4. While the release pin 10 is moving back to the initial position, the ball bearings 4 remain in place until they contact the ramped section 32 of the pull rod 6. The ramped section 32 of the pull rod band the movement of the release pin 10 forces the ball bearings 4 up the ramp section 33 of the spring guide 3, locking the ball bearings 4 back in place on the first outer diameter portion D1 of the pull rod 6.

It should be noted that the force of the bias spring 9 within the bias spring retainer 11 aids the solenoid assembly 5 by providing a spring force through bias spring 9 that is in the same direction as movement of the armature 14 of the solenoid assembly 5. This positive net force reduces the work the solenoid assembly 5 must perform. The additional force provided by the bias spring 9 also allows the force output from the solenoid to be reduced and thus the size of the solenoid can be significantly reduced. In other words, the bias spring 9 acts as a force equivalent of a counterbalance, where a small amount of force has a large impact.

The pin mechanism of the present invention may be used in a fire extinguisher or other similar type device. The pin mechanism of the present invention may be used to rupture a diaphragm, as an emergency override, or deployment of an actuator. Alternatively, the pin mechanism may be used to lock a pin in place.

The pin mechanism of the present invention provides numerous advantages over conventional pin mechanism designs. For example, the pin mechanism of the present invention has a fast solenoid response time of 4 milliseconds (ms) with the bias spring in comparison to a conventional design without a bias spring of 25 ms. A higher force output over long distances is also present within the present invention, with a force of 5 pounds force (lbf) needed in comparison to a conventional design without a bias spring of 30 lbf. The force of the mechanism of the present invention is 425 lbf of stored force, actuated with a solenoid output force of 5 lbf. Furthermore, the mechanism of the current invention has a stroke that ranges in excess of 0.500 inch (in). The power consumption of this embodiment of the present invention is approximately 120 watts, in comparison to 160 watts for a conventional design without a bias spring. In addition, the package size can be made as small as approximately 0.8 in diameter×0.8 in length. Therefore, the present invention provides a greater force over linger distance using a smaller package solenoid.

The pin mechanism of the present invention outputs 3.7 Joules of energy. Other designs may provide 9-10 Joules of energy.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A pin release mechanism comprising:
a release pin axially movable from a first position to a second position;
a bias spring biasing the release pin towards the second position;
a pull rod interacting with a plurality of ball bearings, the pull rod having a locked position in which a plurality of ball bearings radially interfere with movement of the release pin and prevent movement of the release pin from the first position to a second position, and an unlocked position in which the plurality of ball bearings may move radially relative to the pull rod to allow the release pin to move from the first position towards the second position;
a solenoid, which when actuated moves the pull rod toward the unlocked position; and
a bias pin coupled to the pull rod, biased by a spring pushing between the release pin and the bias pin, to bias the bias pin and the pull rod toward the second, unlocked direction.

2. The mechanism of claim 1, wherein the release pin comprises:
a head portion receiving a bias spring retainer;
a neck portion having a bore for receiving a portion of the bias spring retainer and a biased pin guide coupled to the bias pin;
a shaft portion extending a length and defining a cavity connected to the bore of the neck portion, the cavity receiving a portion of the bias pin;
wherein the head portion is connected to the shaft portion through the neck portion.

3. The mechanism of claim 1, wherein the pull rod comprises
a tab received by the solenoid;
a pull end connected to the tab having a first outer diameter portion;
a rod end connected to the pull end through a ramp section, the rod end having a second outer diameter portion, smaller than the first outer diameter portion;
wherein when the plurality of ball bearings move radially relative to the pull rod to allow the release pin to move from the first position towards the second position, the ball bearings travel from the first outer diameter portion to the second outer diameter portion through the ramp section.

4. The mechanism of claim 1, further comprising a housing having a bore for receiving the release pin, the bias spring, the pull rod, the plurality of ball bearings and the bias pin biased by the spring.

5. The mechanism of claim 4, wherein the housing further comprises the solenoid.

6. The mechanism of claim 1, further comprising a spring guide for receiving a portion of the release pin, the pull rod, and the ball bearings, the spring guide being connected to the bias spring.

7. The mechanism of claim 6, wherein the spring guide further comprises a ramp interacting with the plurality of ball bearings when the pull rod is in the locked position.
